(19) United States
(12) Patent Application Publication
(10) Pub. No.: US 2026/0219508 A1
(43) Pub. Date: Jul. 30, 2026

(54) OPTICALLY ALIGNING A TRANSMITTED BEAM WITH A RECEIVED BEAM

(71) Applicant: THE AEROSPACE CORPORATION, El Segundo, CA (US)

(72) Inventors: Juan Montoya, Redondo Beach, CA (US); William Daniel Mack, Los Angeles, CA (US)

(73) Assignee: THE AEROSPACE CORPORATION, El Segundo, CA (US)

(21) Appl. No.: 19/038,192

(22) Filed: Jan. 27, 2025

(51) Int. Cl. G02B 27/28; H04B 10/61

(52) U.S. Cl. CPC G02B 27/283; H04B 10/614

(57) ABSTRACT

Systems and methods for optically aligning a transmitted beam with a received beam are provided herein. In some examples, a received beam is divided into a plurality of receive beamlets. The plurality of receive beamlets are coherently combined into a first optical beam. A second optical beam is coherently divided into a plurality of transmit beamlets forming a transmitted beam. The plurality of receive beamlets are used to determine a direction of the received beam. Phases of the receive beamlets are adaptively adjusted to maximize intensity of the first optical beam. Phases of the transmit beamlets are adaptively adjusted to steer the transmitted beam in a direction opposite to the direction of the received beam.

### FIELD

This application relates to optical communications.

### BACKGROUND

Optical phased arrays (OPA) are useful for electronic beam steering, adaptive-optic compensation, and aperture scaling with reduced need for moving parts, and have been used in applications such as directed energy, light detection and ranging (LIDAR), and down-link free-space optical communications. For further details, see, e.g., Fan, “Laser beam combining for high-power, high-radiance sources,” IEEE Journal of Selected Topics in Quantum Electronics 11 (3): 567-577 (2005); and Montoya et al., “Optical phased-array ladar,” Applied Optics 53 (31): 7551-7555 (2014), the entire contents of which are incorporated by reference herein.

### SUMMARY

Systems and methods for optically aligning a transmitted beam with a received beam are provided herein.

Some examples provide a method for aligning a transmitted beam with a received beam. The method may include dividing a received beam into a plurality of receive beamlets. The method may include coherently combining the plurality of receive beamlets into a first optical beam. The method may include coherently dividing a second optical beam into a plurality of transmit beamlets forming a transmitted beam. The method may include using the plurality of receive beamlets to determine a direction of the received beam. The method may include adaptively adjusting phases of the receive beamlets to maximize intensity of the first optical beam. The method may include adaptively adjusting phases of the transmit beamlets to steer the transmitted beam in a direction opposite to the direction of the received beam.

In some examples, the phases of the receive beamlets are adaptively adjusting using a first two-dimensional array of phase modulators. The phases of the transmit beamlets may be adaptively adjusted using a second two-dimensional array of phase modulators.

In some examples, adaptively adjusting the phases of the receive beamlets includes: individually detecting whether each of the receive beamlets is in-phase or out-of-phase by monitoring the power in the combined beamlet in response to an applied phase dither; and for any receive beamlets detected to be out-of-phase, adaptively adjusting the phase of that receive beamlet until that receive beamlet is in-phase.

In some examples, determining the direction of the received beam includes using a plurality of corresponding sensors to individually detect whether each of the receive beamlets is on-axis or off-axis. Each of the corresponding sensors may include a single-mode optical fiber. When the receive beamlet is on-axis, the single-mode optical fiber of the corresponding sensor generates a single-mode guided beam that coherently combines with other single-mode guided beams from other on-axis receive beamlets.

In some examples, adaptively adjusting the phases of the transmit beamlets includes: detecting intensity of the transmit beam at a far-field of an aperture; and adaptively phase shifting one or more of the transmit beamlets to increase the detected intensity of the transmit beam at the far-field of the aperture.

In some examples, phases of the receive beamlets or phases of the transmit beamlets are adaptively adjusted using a closed loop algorithm. In some examples, the closed loop algorithm includes a modified stochastic parallel gradient descent (SPGD) algorithm.

In some examples, the method further includes using a gimbal to mechanically orient an aperture through which the received beam is received and the transmitted beam is transmitted. The gimbal may be the only mechanical steering component used in the method.

In some examples, the received beam is at a first wavelength, and the transmitted beam is at a second wavelength that is different than the first wavelength.

In some examples, the received beam carries a first signal, and the transmitted beam carries a second signal.

Some examples herein provide a system for aligning a transmitted beam with a received beam. The system may include a first beam combiner to coherently combine a plurality of receive beamlets into a first optical beam. The system may include a plurality of sensors to determine a direction of the received beam. The system may include a first phase modulator array to adjust phases of the receive beamlets. The system may include a second beam combiner to coherently divide a second optical beam into a plurality of transmit beamlets forming a transmitted beam. The system may include a second phase modulator array to adjust phases of the transmit beamlets. The system may include a controller to: adaptively adjust the first phase modulator array to maximize intensity of the first optical beam; and adaptively adjust the second phase modulator array to steer the transmitted beam in a direction opposite the direction of the received beam.

In some examples, the controller is to adaptively adjust the first phase modulator array using operations including: individually detecting whether each of the receive beamlets is in-phase or out-of-phase by monitoring the power in the combined beamlet in response to an applied phase dither; and for any receive beamlets detected to be out-of-phase, adaptively phase shifting that receive beamlet using a corresponding phase modulator until that receive beamlet is in-phase.

In some examples, the plurality of sensors is configured to individually detect whether corresponding ones of the receive beamlets are on-axis or off-axis. Each of the sensors may include a single-mode optical fiber. When the corresponding receive beamlet is on-axis, the single-mode optical fiber of the sensor generates a single-mode guided beam that is coherently combined with other single-mode guided beams from other on-axis receive beamlets.

In some examples, the controller is to adaptively adjust the second phase modulator array using operations including: detecting an intensity of transmitted beam at a far-field of an aperture; and adaptively phase shifting one or more of the transmit beamlets to increase the intensity of the transmitted beam at a far-field of the aperture. In some examples, the intensity of the transmit beam at the aperture is detected using a tap of the transmitted beam focused onto one or more detectors.

In some examples, the controller is to adaptively adjust phases of the receive beamlets or phases of the transmit beamlets using a closed loop algorithm. In some examples, the closed loop algorithm includes a modified stochastic parallel gradient descent (SPGD) algorithm.

In some examples, the received beam is at a first wavelength, and the transmitted beam is at a second wavelength that is different than the first wavelength.

In some examples, the received beam carries a first signal, and the transmitted beam carries a second signal.

In some examples, the system further includes a gimbal to mechanically orient an aperture through which the receive beam is received and the transmitted beam is transmitted, wherein the gimbal is the only mechanical steering component used in the system.

Some examples herein provide a method for characterizing alignment of an optical beam. The method may include, when the optical beam is on-axis, directing the optical beam to a single-mode optical fiber to generate a single-mode guided beam. The method may include, when the optical beam is off-axis, directing the optical beam to a multi-mode optical fiber of a plurality of multi-mode optical fibers arranged around the single-mode optical fiber in a plane, to generate a multi-mode guided beam. The method may include using the single-mode guided beam, when present, to characterize the optical beam as being on-axis. The method may include using the multi-mode guided beam, when present, to characterize an off-axis angle and wavefront tilt of the optical beam.

In some examples, the plurality of multi-mode optical fibers includes a first multi-mode optical fiber configured to receive the optical beam when the optical beam is in a first quadrant of the plane. In some examples, the plurality of multi-mode optical fibers includes a second multi-mode optical fiber configured to receive the optical beam when the optical beam is in a second quadrant of the plane. In some examples, the plurality of multi-mode optical fibers includes a third multi-mode optical fiber configured to receive the optical beam when the optical beam is in a third quadrant of the plane. In some examples, the plurality of multi-mode optical fibers includes a fourth multi-mode optical fiber configured to receive the optical beam when the optical beam is in a fourth quadrant of the plane.

In some examples, the at least one optical element includes at least one phase plate. In some examples, the at least one optical element includes at least one lens.

In some examples, the at least one optical element includes a lens and a lens array. The lens array may be disposed between the lens and the plane.

In some examples, each of the multi-mode optical fibers has a numerical aperture of at least about 0.3.

In some examples, each of the multi-mode optical fibers has a numerical aperture of at least 0.3.

In some examples, each of the multi-mode optical fibers supports at least about 500 different modes.

Some examples herein provide a sensor for characterizing an optical beam. The sensor may include a single-mode optical fiber. The sensor may include a plurality of multi-mode optical fibers arranged around the single-mode optical fiber in a plane. The sensor may include at least one optical element configured to direct the optical beam to the single-mode optical fiber when the optical beam is on-axis to generate a single-mode guided beam, and to direct the optical beam to one of the multi-mode optical fibers when the optical beam is off-axis to generate a multi-mode guided beam.

In some examples, the sensor further includes a controller configured to: use the single-mode guided beam, when present, to characterize the optical beam as being on-axis; and use the multi-mode guided beam, when present, to characterize an off-axis angle and wavefront tilt of the optical beam.

In some examples, the plurality of multi-mode optical fibers includes a first multi-mode optical fiber configured to receive the optical beam when the optical beam is in a first quadrant of the plane. In some examples, the plurality of multi-mode optical fibers includes a second multi-mode optical fiber configured to receive the optical beam when the optical beam is in a second quadrant of the plane. In some examples, the plurality of multi-mode optical fibers includes a third multi-mode optical fiber configured to receive the optical beam when the optical beam is in a third quadrant of the plane. In some examples, the plurality of multi-mode optical fibers includes a fourth multi-mode optical fiber configured to receive the optical beam when the optical beam is in a fourth quadrant of the plane.

In some examples, the at least one optical element includes at least one phase plate.

In some examples, the at least one optical element includes at least one lens.

In some examples, the at least one optical element includes a lens and a lens array, wherein the lens array is disposed between the lens and the plane.

In some examples, each of the multi-mode optical fibers has a numerical aperture of at least about 0.3.

In some examples, each of the multi-mode optical fibers has a numerical aperture of about 0.5.

In some examples, each of the multi-mode optical fibers supports at least about 500 different modes.

### BRIEF DESCRIPTION OF DRAWINGS

FIG. 1A schematically illustrates components of an example system for optically aligning a transmitted beam with a received beam.

FIG. 1B schematically illustrates components of another example system for optically aligning a transmitted beam with a received beam.

FIG. 2A schematically illustrates components of an example receive (RX) beam combiner for use in optically aligning a transmitted beam with a received beam.

FIG. 2B schematically illustrates components of an example transmit (TX) beam combiner for use in optically aligning a transmitted beam with a received beam.

FIG. 3 schematically illustrates an example detector for use in determining direction of a received beam.

FIGS. 4A-4E schematically illustrate other example detectors for use in determining direction of a received beam.

FIG. 5 illustrates a flow of operations in an example method for optically aligning a transmitted beam with a received beam.

FIG. 6 illustrates an example interference pattern function, and its derivative, for use in the present systems and methods.

FIGS. 7A-7C schematically illustrate example wavefronts in the present systems and methods.

FIG. 8 schematically illustrates a notional example of detectors used to steer an array.

FIG. 9 illustrates simulated results from a phased array.

FIGS. 10A-10C schematically illustrate example uses of a phased array to steer a transmitted beam.

FIGS. 11A-11C are two-dimensional phase control results generated using the phased array in the manner described with reference to FIGS. 10A-10C.

FIGS. 12A-12B, 13A-13B, and 14A-14B schematically illustrate different aspects of a beam under selected conditions.

FIG. 15 schematically illustrates an example detector array geometry.

### DETAILED DESCRIPTION

Systems and methods for optically aligning a transmitted beam with a received beam are provided herein. For example, in a manner such as described herein, both the transmitted beam and the received beam may be electronically steered, thus significantly reducing (or even obviating) the need for mechanical steering components such as gimbals, piezoelectric steering components such as nutators, or the like. The present systems and methods are readily scalable and reduce the size, weight, and power (SWaP) of components needed to align transmitted and received beams with one another. The present systems and methods may be used in any suitable communications link, including but not limited to space-to-space (S2S), crosslinks, space to ground, ground to space, space to air, and/or air to space. For example, the present systems may be located in, and implemented at, any suitable space vehicle, such as a satellite; an optical ground station; or a moving vehicle, such as a ground vehicle, air vehicle, or sea vessel.

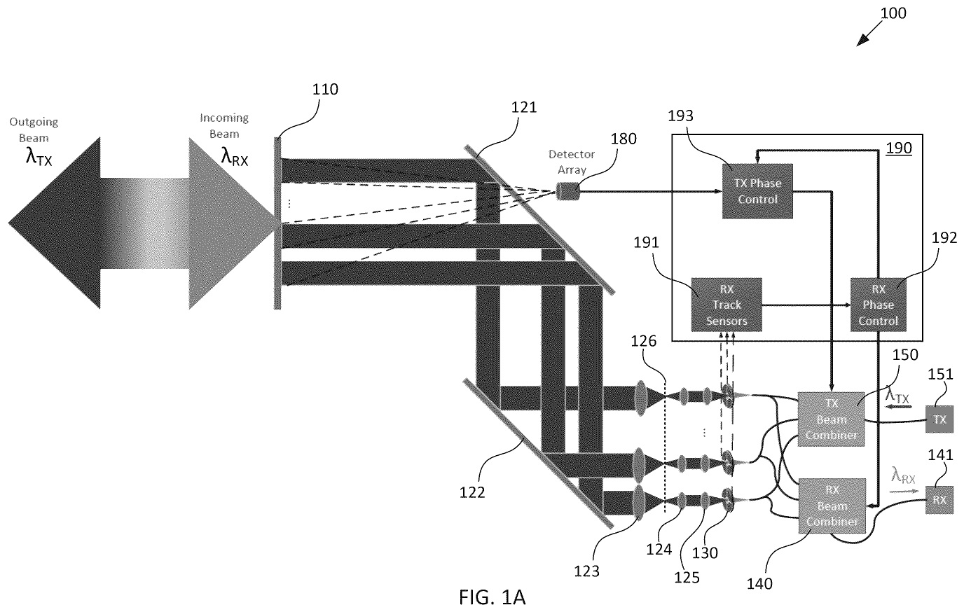

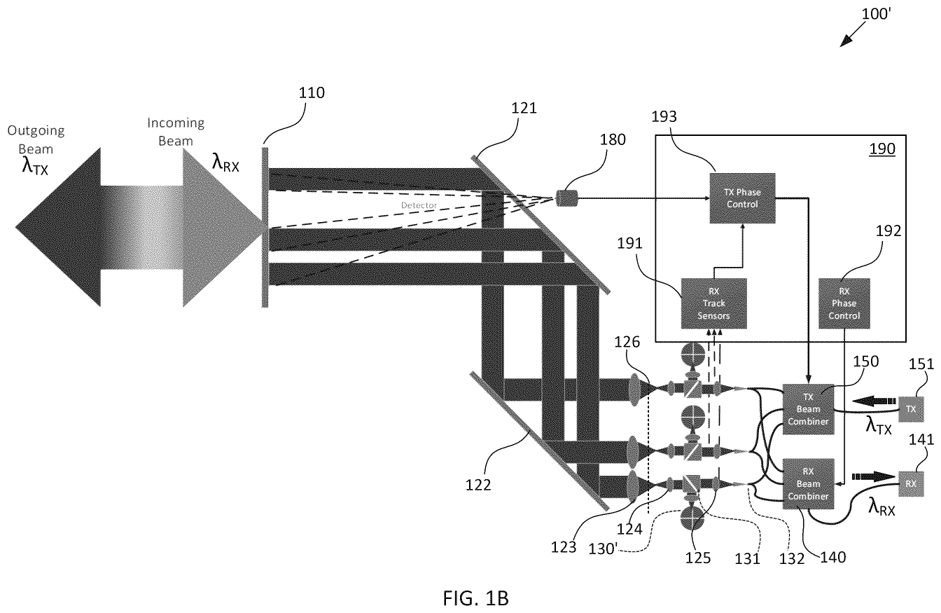

FIG. 1A schematically illustrates components of an example system 100 for optically aligning a transmitted beam (outgoing beam) with a received beam (incoming beam). System 100 may receive the received beam via aperture 110. The received beam may be at a first wavelength (λ_{RX}) and may carry a first signal. System 100 may include additional optical components to optically process and transmit the received beam from aperture 110 to a receiver (RX) 141 to be decoded and used as appropriate. For example, system 100 may include free-space mirrors 121, 122 configured to steer the received beam to an array of free-space lenses 123, 124, 125 configured to focus the beam into guided-wave optical component(s) (described in greater detail below) and from there to the receiver 141. System 100 also may receive the received beam via aperture 110. The transmitted beam may be at a second wavelength (λ_{TX}) that is different than the first wavelength, and may carry a second signal. System 100 may use at least some of the same additional optical components to optically process and transmit the transmitted beam from a transmitter (TX) 151 to the aperture 110 as the system uses to transmit and process the received beam. For example, guided-wave optical component(s) (described in greater detail below) may transmit the beam from the transmitter 151 to free space lenses 123, 124, 125 which expand the transmit beam that free-space mirrors 121, 122 then steer to aperture 110 for transmission to a remote device which, in some examples, may be configured similarly as system 100. Regardless of the particular configuration of the remote device, system 100 may be configured to determine the received beam's direction, and to align the transmitted beam opposite to that direction to facilitate sufficiently robust communication between system 100 and the remote device.

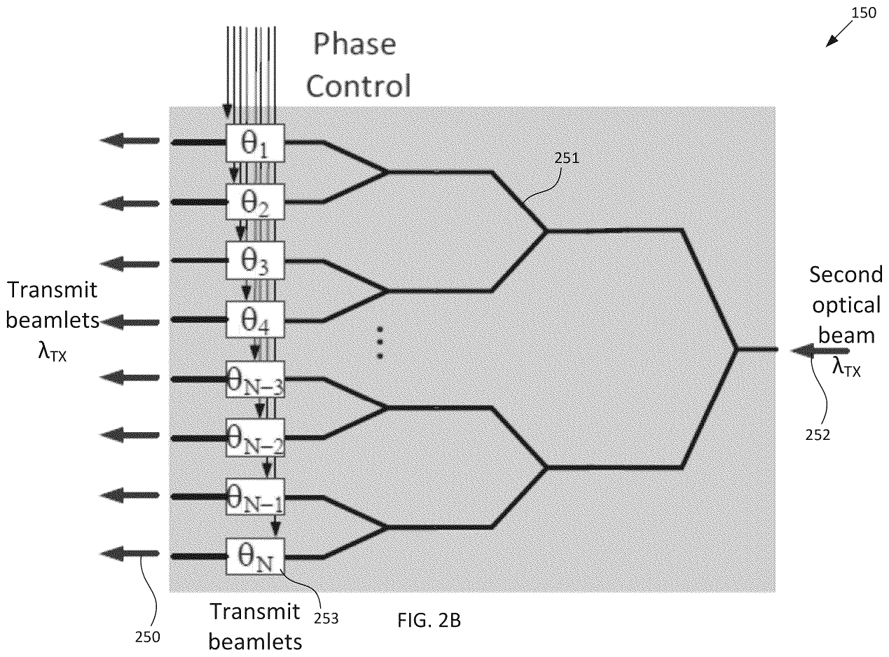

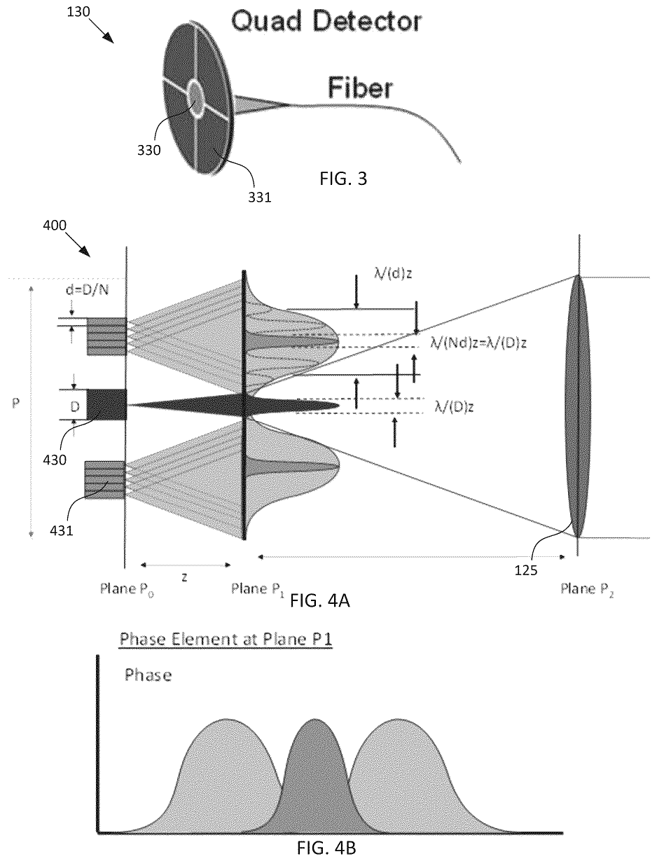

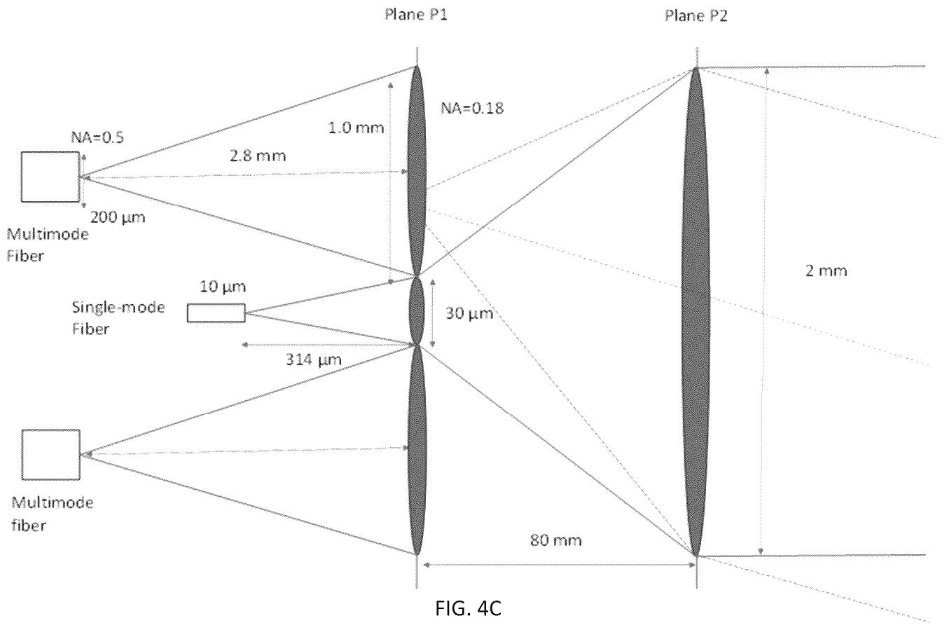

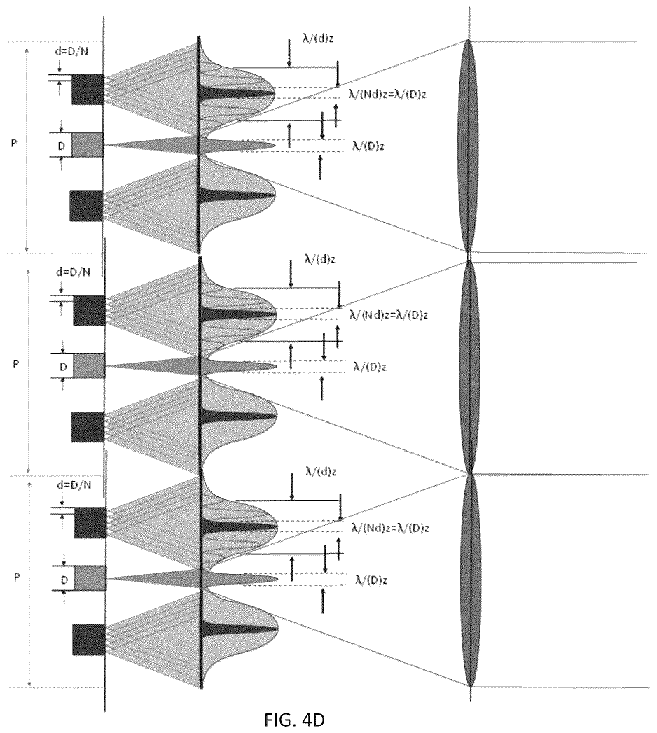

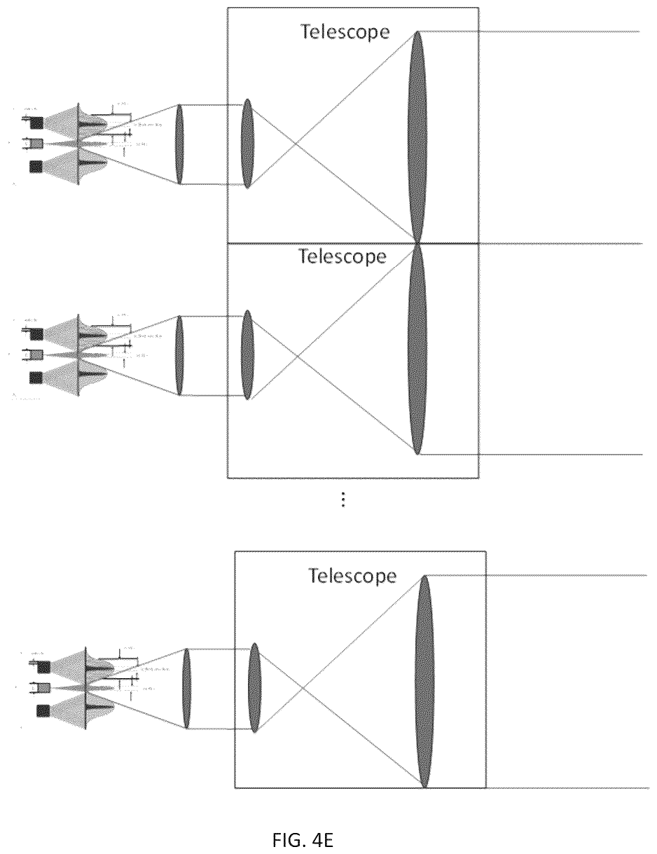

Illustratively, in the nonlimiting example illustrated in FIG. 1A, system 100 includes a first beam combiner 140 (also referred to as an RX beam combiner) and a second beam combiner 150 (also referred to as a TX beam combiner). Note that the terms beam splitter and beam combiner may be used interchangeably herein, in circumstances in which the same device may be used to split a beam into beamlets or to combine beamlets into a beam, depending on the direction of the beam through the device. In the nonlimiting configuration illustrated in FIG. 1A, a plurality of free space lenses 123 may focus different portions of the receive beam to points in an image plane 126. Free space lenses 123 and 124 demagnify the received beamlets, while free space lenses 125 bring the received beamlets to a respective focus at a plane containing track/com sensors 130. In some examples, the track/com sensors 130 may be configured in a manner such as described below with reference to FIGS. 3 and 4A-4E. When the received beamlets arrive on-axis parallel to the normal of aperture 110, the received beamlets strongly overlap with the fibers located in the center of the track/com sensors 130. Typically, at least about 80% of the power is coupled into the center fibers while the remaining amount of the power (e.g., about 20% or less) overlaps on the quad cells that surround the fibers (e.g., in a manner such as described with reference to FIG. 3). When the received beamlets arrive off axis at an angle α with a value between 0 and λN/D, the received beamlets will translate in the track/com sensor plane, will have reduced overlap with the central com fibers of the track/com sensors 130, and will have increased overlap relative to the on-axis case, with the quadrant detectors that surround the central com fibers. When the angle α is significantly larger than λN/D, the received beams will miss the fibers entirely and overlap only on the quadrant detectors. In certain examples provided herein, the track/com sensors 130 provide a measure of the angular error that may, in some examples, be used to mechanically steer a gimbal (not specifically shown) to mechanically steer the received beamlets to within the angular acceptance of the array of track/com sensors 130. The center fibers in respective track/com sensors 130 may be coupled via fiber optics (not specifically labeled) to first beam combiner 140.

Alternatively, one or more beam splitters with appropriate coating may be used to allow sampling of the receive beamlets onto respective quadrant detectors for tracking. In such examples, free space lenses may be used to focus the receive beamlets directly into fiber optics which are coupled to first beam combiner 140. For example, FIG. 1B schematically illustrates components of another example system 100′ for optically aligning a transmitted beam (outgoing beam) with a received beam (incoming beam). System 100′ may be configured similarly as system 100 in many regards, as represented by use of the same elements labeled using the reference numbers in both FIGS. 1A and 1B. However, instead of track/com sensors 130 to both track and receive the receive beamlets as described with reference to FIG. 1A, system 100′ includes conventional quad sensors 130′ to track the receive beamlets and fibers 132 to receive the receive beamlets. In this example, beam splitters 131 split respective ones of the receive beamlets into a first portion and a second portion. The first portion is focused on a respective quad sensor 130′ the output of which RX track sensors module 191 uses to track the receive beamlets in the manner described with reference to FIG. 1A. The second portion is focused (e.g., using lens 125) onto fibers 132 which are coupled to receive beam combiner 140 for use in a manner such as described with reference to FIG. 1A.

Furthermore, the inventors recognize that the track/com sensors 130 may be oriented at different relative angles relative to each other in such a manner to reduce the ambiguity that results when the received beamlets reside in a single quadrant. For example, if all the received beamlets reside in the top left quadrant across all of the respective sensors, there is ambiguity as to the location of the beam within the upper quadrant and hence ambiguity in the angle of arrival of the received beam coming through aperture 110. If one or more sensors are rotated by 45 degrees relative to an unrotated sensor, then a comparison of the registration of the received beamlet in the rotated and unrotated sensors reduces the ambiguity by a factor of 2. For example, a received beamlet measured in quadrant I of a first sensor, and also registered in quadrant I′ of a second sensor rotated by negative 45 degrees relative to the first sensor, allows determination that the beam resides in the lower half of quadrant I.

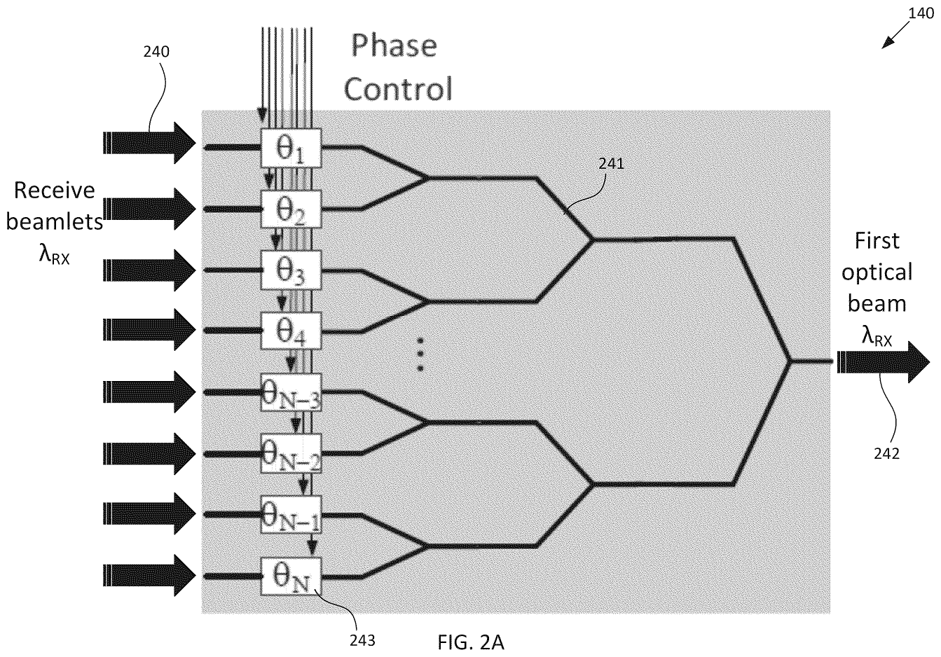

First beam combiner 140 may be configured to coherently combine a plurality of receive beamlets into a first optical beam which is output to receiver 141. For example, FIG. 2A schematically illustrates components of an example receive beam combiner 140 for use in optically aligning a transmitted beam with a received beam. Beam combiner 140 receives beamlets 240 of the received beam, e.g., from respective track/com sensors 130 as described with reference to FIG. 1A or from respective fiber optics 132 as described with reference to FIG. 1B. As illustrated in FIG. 2A, beam combiner 140 includes a plurality of guided-wave (e.g., fiber optic) pathways 241 which coherently combine the receive beamlets with one another to form a first optical beam 242 which is transmitted to receiver 141 via a guided-wave (e.g., fiber optic) pathway. Receive beam combiner 140 further may include a first phase modulator array 243 to adjust phases of the receive beamlets, e.g., in a manner such as will be described in greater detail below.

Second beam combiner 150 may be configured to coherently divide a second optical beam into a plurality of transmit beamlets forming a transmitted beam. For example, second beam combiner 150 may receive the second optical beam from transmitter 150 via fiber optics, and may be coupled to track/com sensors 130 via fiber optics (not specifically labeled) or to quad detectors 132 described with reference to FIG. 1B. FIG. 2B schematically illustrates components of an example transmit (TX) beam combiner for use in optically aligning a transmitted beam with a received beam. Beam combiner 150 receives second optical beam 252 from transmitter 251 via a guided-wave (e.g., fiber optic) pathway. As illustrated in FIG. 2B, beam combiner 150 includes a plurality of guided-wave (e.g., fiber optic) pathways 251 which coherently divide the second optical beam 252 into transmit beamlets 250. The beamlets 250 then are transmitted to respective track/com sensors 130 as described with reference to FIG. 1A or to fiber optics 132 described with reference to FIG. 1B via a guided-wave (e.g., fiber optic) pathway, and from there to aperture 110 via free-space optics. Receive beam combiner 150 further may include a second phase modulator array 253 to adjust phases of the transmit beamlets, e.g., in a manner such as will be described in greater detail below.

Referring again to the nonlimiting example shown in FIG. 1A, track/com sensors 130 may be used to determine a direction of the received beam. FIG. 3 schematically illustrates an example track/com sensor 130 for use in determining direction of a received beam. In this example, track/com sensor 130 may include a centrally located single-mode fiber 330 and four optical or electronic quadrants 331 arranged about the fiber 330. When the corresponding receive beamlet 240 received by the track/com sensor 130 is on-axis, the single-mode optical fiber 330 of the sensor generates a single-mode guided beam that is coherently combined with other single-mode guided beams from other on-axis receive beamlets, e.g., within first beam combiner 140. When the corresponding receive beamlet 240 received by the sensor is off-axis, the quadrant(s) 331 receiving that beamlet generate an electrical signal which is provided to controller 190.

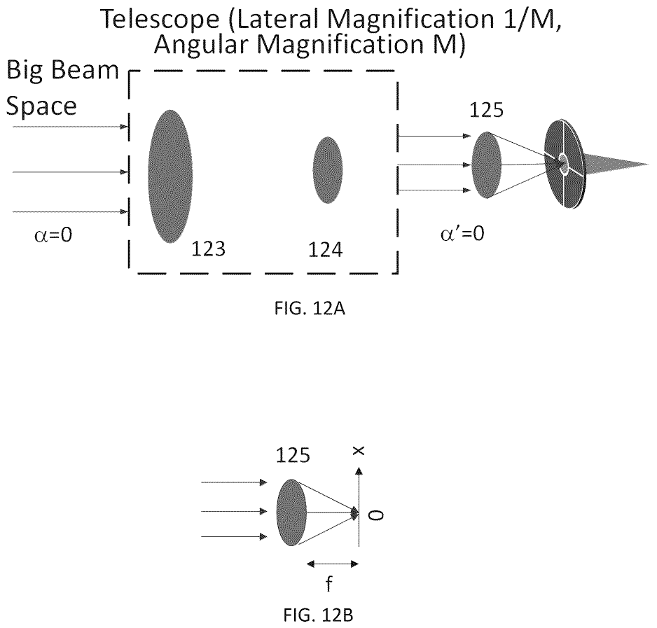

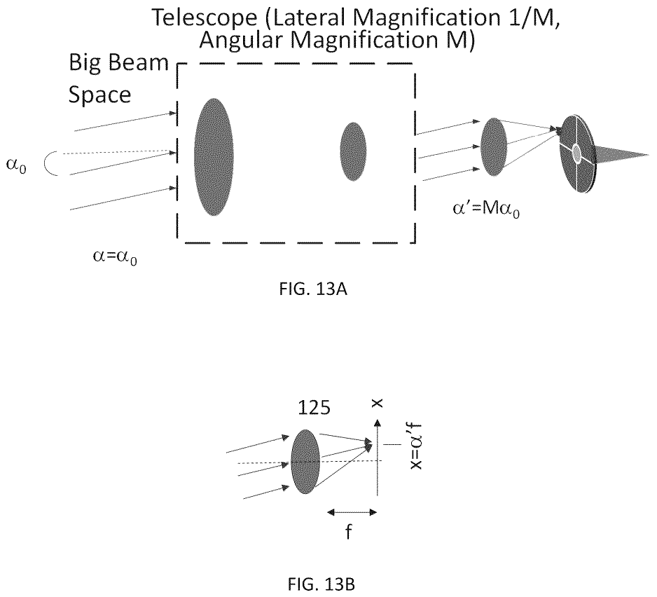

In a manner such as described with reference to FIGS. 1A, 2A, and 3, free-space lenses 123, 124, 125 may be used to focus the receive beamlets 240 to spot sizes that match that of the single-mode fiber 330, expressed as dimension S. Off-axis light is displaced on the track/com sensor 130 by distance x=αƒ, where ƒ is the focal length of lens 125 and α is the angle of displacement. In reference to FIG. 1A, the received beamlet before being subject to the telescope demagnification resides in what is commonly referred to as big beam space. For example, FIGS. 12A-12B, 13A-13B, and 14A-14B schematically illustrate different aspects of a beam under selected conditions. Upon demagnification, the received beamlet is said to reside in small beam space. The telescope including lenses 123 and 124 illustrated in FIGS. 1A, 12A, and 13A demagnify the beam by a factor 1/M which may be referred to as the lateral magnification. In accordance with the lens conservation laws, the angular magnification is M. The largest angular acceptance in small beam space is αₘₐₓ=L/ƒ for a track/com sensor 130 of diameter L and focal length ƒ of lens 125. In big beam space, the largest angular acceptance is demagnified by 1/M resulting in αₘₐₓ=L/(fM). Angles exceeding αₘₐₓ will cause the focused beam to miss the track/com sensor 130.

As recognized by the present inventor, the angular dynamic range of the track/com sensor 130 may be expressed as L/S, where L is the dimension of the track/com sensor 130; the largest angle in the angular dynamic range of the track/com sensor may be expressed as L/ƒ; and the smallest angle αₘᵢₙ incident on the lens 125 in small beam space corresponds to the beam divergence in big beam space multiplied by the angular magnification as in (min=(λ/D_{sub}) M and may also be expressed as S/ƒ where S is simply αₘᵢₙƒ. In examples in which a telescope is used to focus the receive beamlets onto respective track/com sensors 130 in a manner such as illustrated in FIGS. 1A, 12A, and 13A (lenses 124, 125 in this example), both the largest angle and the smallest angle are scaled in the big beam space by the angular magnification, so the dynamic range does not change relative to examples in which a telescope is not used in such a manner. Some examples of achieve approximately 30 urads with a field of view of about 2 mrad in the big beam space. The dynamic range in such examples is approximately 67, such that for an example value of L=0.67 mm, a spot size of approximately S=0.67 mm/67, or approximately 10 μm, may be used to match a single mode fiber of core size 10 μm. As used herein, terms such as “about” and “approximately” mean within 10 percent above or below the stated value.

Referring again to FIGS. 1A, 1B, and 2A, controller 190 may be configured to adaptively adjust the first phase modulator array 243 of first beam combiner 140 to increase or maximize intensity of the first optical beam 242. For example, controller 190 may be configured to adaptively adjust the first phase modulator array 243 using operations that include individually detecting whether the average of received beamlets 240 is on-axis or off-axis, e.g., based on signals provided by respective track/com sensors 130 or by quad detectors 130′ for those receive beamlets 240. For any averaged of received beamlets 240 that controller 190 detects to be off-axis, controller 190 adjusts the gimbal consisting of mirrors 121 and 122 to steer the beam on-axis while adaptively applying phase correction to the individual receive beamlets using a corresponding phase modulator 243 until that receive beamlet is in phase with the other receive beamlets. When all of the receive beamlets 240 are on-axis and in phase with one another, intensity of the first optical beam 242 is maximized, and the direction of the received beam is known.

In the nonlimiting example illustrated in FIG. 1A, controller 190 may include a receive (RX) track sensors module 191 which is configured to receive signals from each of the track/com sensors 130 and to determine a direction and degree by which the corresponding beamlet is off-axis; and a receive phase (RX) control module 192 which is configured to adaptively control each of the phase modulators of array 243 to adjust the receive beamlets' respective phases until that the beamlets are on-axis and in phase with one another. In practice, the phased array provides the fine-steering capability and has a narrow field of view relative to the large field of regard of the gimbal and the larger field of view of the track sensor. Accordingly, the gimbal control loop works to center the beamlets on respective track/com sensors 130 or quad sensors 130′ in a coarse and slow (lower bandwidth) fashion. When the beamlets are within the angular capture range of the optical phased array, the array 243 adjusts the beamlets to maximize the beam intensity in the first optical beam 242.

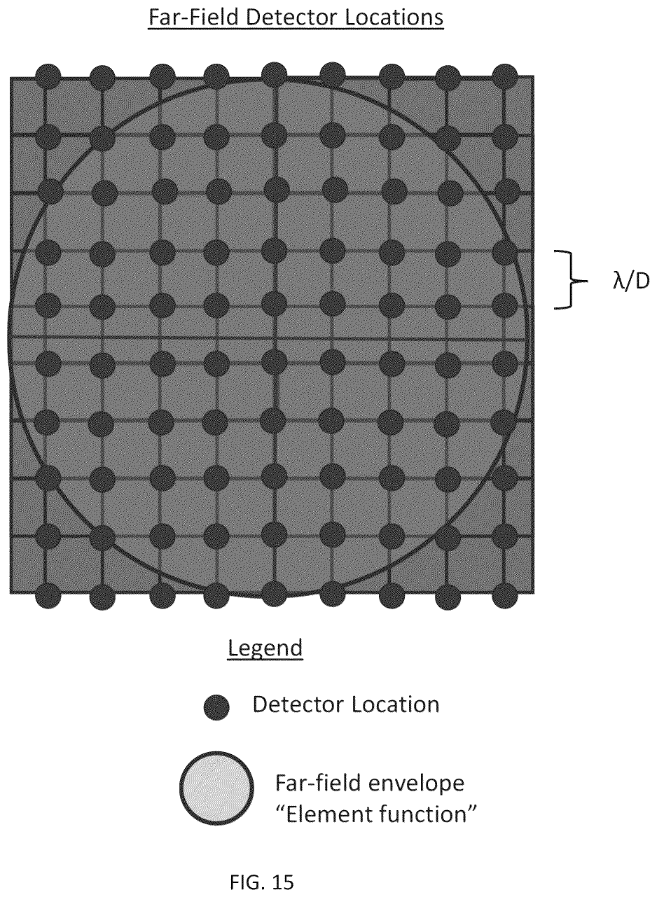

Additionally, referring again to FIGS. 1A, 1B and 2B, controller 190 also may be configured to adaptively adjust the second phase modulator array 253 to steer the transmitted beam in a direction opposite the direction of the received beam. For example, controller 190 may be configured to detect an intensity of transmitted beam at a far-field of aperture 110. Illustratively, system 100 may include a detector array 180 which is configured to image the transmitted beam at the far-field of aperture 110, for example using a tap of the transmitted beam focused onto the detector array. The detector array 180 may generate signal which is provided to a transmit phase control module 192 of controller 190, that is configured to adaptively phase shift one or more of the transmit beamlets to increase the intensity of the transmitted beam at a far-field of the aperture. The detector array 180 may include a plurality of fibers spaced half a beam-width apart. Because a phased array is steerable over N beamwidths, the detector array 180 will require at most 2N detectors per axis to cover the entire steering range for a total of at most 4N² detectors, although more or fewer detectors than this can of course be used in any given implementation. An example geometry is included in FIG. 15. The detector spacing may be tailored to achieve the desired steering range within the full phased array capability.

Referring again to FIGS. 1A and 1B, controller 190 may be configured to adaptively adjust phases of the receive beamlets or phases of the transmit beamlets using a closed loop algorithm, such as a modified stochastic parallel gradient descent (SPGD) algorithm.

In some examples, the modified SPGD algorithm may be derived by analogy with Newton's method for iteratively solving for the roots of a function. For illustration, consider the 1-D interference pattern in the far-field f(x,θ)=½ (1+cos (2π/P x+θ)) along an axis parallel to the array arising from the interference between two elements with phase difference θ. The period of the interference pattern P=λ/(2 sinφ) is dependent on the angle φ between the two beams. A detector located on-axis (x=0) results in an interference pattern f(θ)=½ (1+cos (θ)) that is dependent on the phase difference θ between the two elements. Newton's method allows for iteratively solving for the roots of a function using

$${θ}_{N + 1} = {θ}_{N} - \frac{f ( {θ}_{N} )}{{f}^{′} ( {θ}_{N} )} . \qquad ( 1 )$$

Finding the maximum of a function f(θ_{N}) is equivalent to finding the root of ƒ′(θ_{N})=0. Substituting the derivative ƒ′(θ_{N}) for ƒ(θ_{N}) in eq. 1 results in the Newton method for finding θ_{N} that maximizes ƒ(N)

$${θ}_{N + 1} = {θ}_{N} - \frac{{f}^{′} ( {θ}_{N} )}{{f}^{″} ( {θ}_{N} )} . \qquad ( 2 )$$

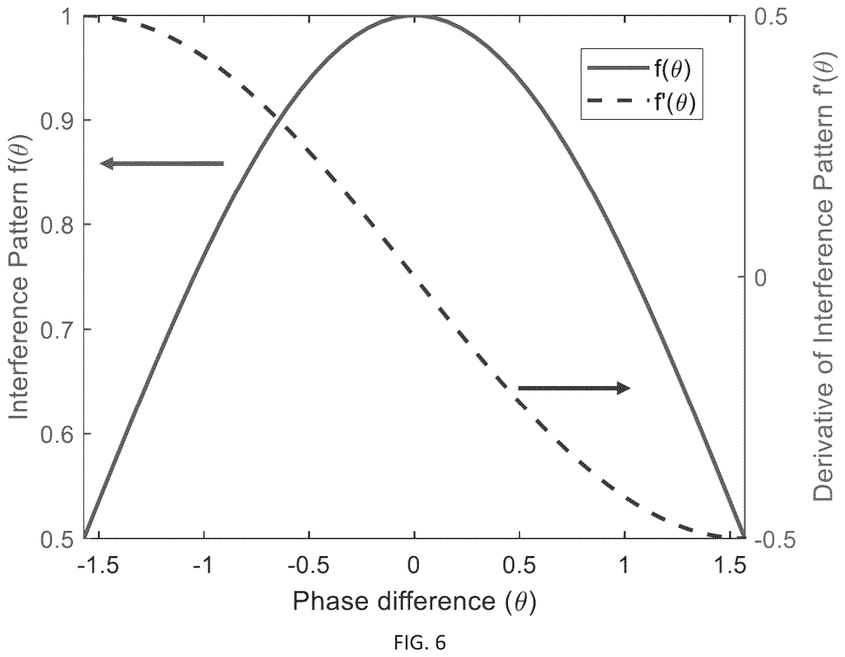

In the two-element interference example, starting with an initial value or estimate for the phase θ₀, Newton's method iteratively converges on the phase θ_{N} that maximizes the intensity by numerically solving for the roots of the derivative of the interference pattern. FIG. 6 illustrates an example interference pattern function, and its derivative, for use in the present systems and methods. Recognizing that the derivative has a zero-crossing at the maximum as shown in FIG. 6, eq. 2 may be modified to allow for a steering offset α (or non-zero slope) as shown in eq. 3:

$${θ}_{N + 1} = {θ}_{N} - \frac{f ′ ( {θ}_{N} ) - α}{{f}^{″} ( {θ}_{N} )} \qquad ( 3 )$$

As recognized by the present inventor, the steering offset α in eq. 3 allows for a new form of beam steering. As provided herein, the present systems and methods include one or more of the following features: calculating α, optionally implementing α using SPGD, and measuring α using two detectors. This provides an innovative sensor arrangement which allows discrete sampling in the far-field and interpolation between discrete samples to allow for continuous steering, e.g., continuous closed loop SPGD steering.

According to the two-element example, setting α=0 results in solving for the maximum intensity on-axis (zero-slope). On the other hand, a positive value of α results in the interference fringes being steered to the left while a negative value of α results in the interference fringes being steered to the right. In the two-element example, the intensity near the maximum may be approximated as being quadratic (i.e. cos (x)~1−x²/2) which holds true for higher dimensions with more elements. For more elements, the Maréchal approximation may be applied, which states that the on-axis intensity is given by the RMS error of the phase across the wavefront and may be expressed as:

$$S ∼ {e}^{- {θ}_{RMS}^{2}} ∼ 1 - {θ}_{RMS}^{2} \qquad ( 4 )$$

For M independent phase elements, the Strehl ratio may be approximated by the sum of the RMS errors along M independent axes, as expressed in eq. 5 and described in Redmond et al., “Active coherent combination using hill climbing-based algorithms for fiber and semiconductor amplifiers,” Coherent Laser Beam Combining, Wiley Semiconductors, Arnaud Brignon, Ed., pages 103-136 (2013), the entire contents of which are incorporated by reference herein.

$$S ∼ {e}^{- ( {θ}_{RMS , 1}^{2} + {θ}_{RMS , 2}^{2} ... {θ}_{RMS , M}^{2} )} ∼ {e}^{- ( {θ}_{RMS , 1}^{2} )} {e}^{- ( {θ}_{RMS , 2}^{2} )} … {e}^{- ( {θ}_{RMS , M}^{2} )} . \qquad ( 5 )$$

The phase error across the array thus may be expressed as a separable form that turns the problem from finding an M-dimensional solution into a solution involving the product of M separable solutions each involving a single scalar unknown θ_{RMS,i}.

The M-element problem may be further simplified into the product of (M−1) two-element problems because the absolute phase of the array is arbitrary. SPGD is well suited for maximizing functions of the form of a second order polynomial, f(θ)=a+bθ+cθ². For a maximum to exist, the second derivative must be a negative constant. Using the analogy with Newton's method, the SPGD control algorithm may be written in the form:

$${θ}_{N + 1} = {θ}_{N} + {gf}^{′} ( {θ}_{N} ) \qquad ( 6 )$$

As is the case with Newton's method, the one-dimensional expression may be extended to higher dimensions by replacing the scalar quantities with vectors, and the first derivative with a gradient.

$$\vec{{θ}_{N + 1}} = \vec{{θ}_{N}} + g ( ∇ f ( \vec{{θ}_{N}} ) ) \qquad ( 7 )$$

Stochastic parallel gradient descent as applied to optical phased array correction uses a dither approach to approximate the gradient ∇f(\vec{θ_{N}}). If there are N orthonormal dither vectors \vec{δₗ}, (with i ranging from 1 to N), the gradient along the direction \vec{δₗ} is approximated by measuring the response to a dither at a detector with a positive sign J⁺=f(\vec{θ_{N}}+\vec{δₗ}) followed by a measurement of the applied dither with a negative sign J⁻=f(\vec{θ_{N}}−\vec{δₗ}). The difference (J⁺−J⁻)\vec{δₗ} then approximates the gradient along direction \vec{δₗ}. It may be useful to normalize the gain by the sum (J⁺−J⁻) to remove the intensity dependence on the gain, in a manner such as described in Kansky et al., “Beam control of a 2D polarization maintaining fiber optic phased array with high-fiber count,” SPIE Proceedings Volume 6306, Advanced Wavefront Control: Methods, Devices, and Applications IV; 63060G (2006), the entire contents of which are incorporated by reference herein.

$$\vec{{θ}_{N + 1}} = \vec{{θ}_{N}} + g {\sum }_{i} \frac{( {J}^{+} - {J}^{-} )}{( {J}^{+} + {J}^{-} )} \vec{{δ}_{ι}} . \qquad ( 8 )$$

Inspection of eq. 8 illustrates that the SPGD algorithm iteratively solves for the angle where the derivative is zero which occurs at a maximum. When J+=J−, future updated phase values do not change from previous values (\vec{θ_{N+1}}=\vec{θ_{N}}), indicating a maximum has been reached.

Similar to Newton's method, incorporating a phase tilt across the array simply requires the addition of an offset. Accordingly, the algorithm involves modifying eq. 8 to allow for an offset term that is a function of the tilt angle α for each dither as shown in eq. 9:

$$\vec{{θ}_{N + 1}} = \vec{{θ}_{N}} + g {\sum }_{i} [ \frac{( {J}^{+} - {J}^{-} )}{( {J}^{+} + {J}^{-} )} - ( {offset}_{i} ( α ) ) ] \vec{{δ}_{ι}} . \qquad ( 9 )$$

The offset may be calculated a) analytically, or b) measured experimentally by closing the loop on a discrete detector in the far-field while measuring the dither response

$$\frac{( {J}^{+} - {J}^{-} )}{( {J}^{+} + {J}^{-} )}$$

on a detector located at an angular offset α. The offset for each dither is linearly proportional to the offset angle α relative to a detector at angle α₀ for angular offsets within the range of α~+/−½ W where W is the full-width half-maximum of the main lobe. This is similar to the two-element example shown in FIG. 6 where the slope is linear near the peak. The proportionality constant is dither dependent and may be determined for each dither. As a result of the linearity, measurements on two detectors spaced approximately ½ W apart determine the offset and may be used to steer and interpolate to any location between the two detectors. Denoting the dither response measurements for dither i on detector A as

$${M}^{A , i} = \frac{( {J}^{+} - {J}^{-} )}{( {J}^{+} + {J}^{-} )}$$

and on detector B as

$${M}^{B , i} = \frac{( {J}^{+} - {J}^{-} )}{( {J}^{+} + {J}^{-} )}$$

provides the interpolated SPGD expression given in eq. 10:

$$\vec{{θ}_{N + 1}} = \vec{{θ}_{N}} + g {\sum }_{i} [ {M}^{A , i} {G}_{A} + {M}^{B , i} {G}_{B} ] \vec{{δ}_{ι}} \qquad ( 10 )$$

in which interpolation constants may be expressed as G_{A}=½ (1+Δ) and G_{B}=½ (1−Δ). In accordance with eq. 10, when Δ=1, G_{A}=1, and G_{B}=0. The SPGD expression reverts to the conventional form for optimizing the beam centered on detector A. The detector roles are reversed when Δ=−1, resulting in (G_{A}=0, G_{B}=1) allowing for optimizing the beam on detector B. Other values of A between −1 and 1 allow for linearly steering the beam between detectors A and B. In particular, a value of Δ=0 results in steering the beam midway between detectors A and B.

The modified SPGD expressions in eqs. 9 and 10 have been verified and anchored through simulations and experiments, described below in the working examples.

For further details regarding SPGD algorithms, see Vorontsov et al., “Stochastic parallel-gradient-descent technique for high-resolution wave-front phase distortion correction,” Journal of the Optical Society of America A 15 (10): 2745-2758 (1998), the entire contents of which are incorporated by reference herein.

### Optical Phased Array Steering

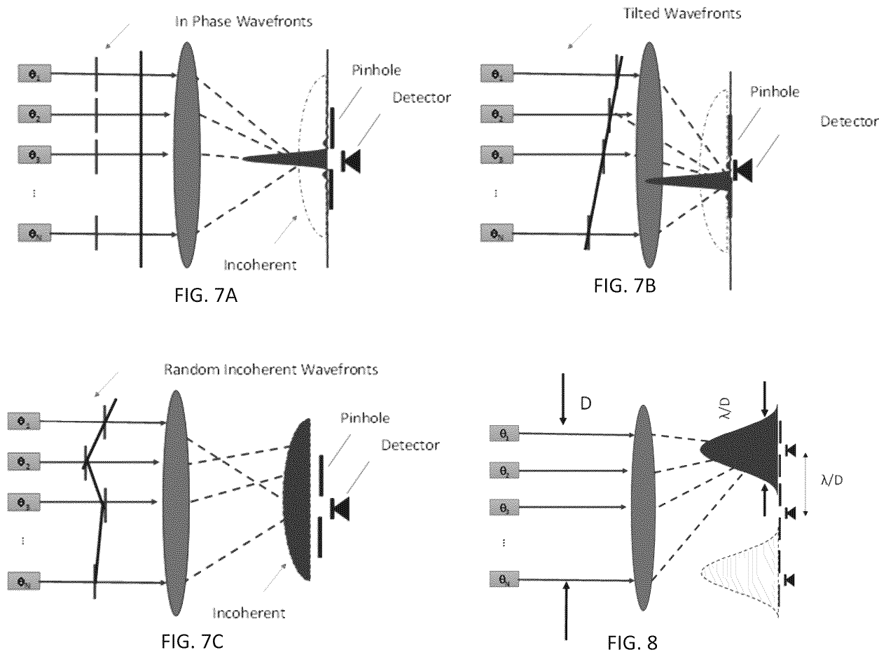

Eq. 9 will now be further examined in the example context of an optical phased array. For an optical phased array, an array of plane-wave emitters may be considered, in which each emitter element is focused on-axis through a Fourier lens. The intensity on-axis corresponds to the squared magnitude of the electric field on-axis in the Fourier plane. This field arises from the incident electric field of the individual emitters and may be expressed as

$$I = {‖ {\sum }_{i} {a}_{i} {e}^{j {θ}_{i}} ‖}^{2} , \qquad ( 11 )$$

where the field amplitude is expressed as αᵢ, the phase shift is expressed as θᵢ, and the index i ranging from 1 to N denotes the emitter element. From geometric optics, the on-axis component in the far-field (focal plane of the lens) arises from the focus of all rays parallel to the optical axis. FIGS. 7A-7C schematically illustrate example wavefronts in the present systems and methods. In the example shown in FIG. 7A, a flat wavefront adds constructively on-axis. In the example shown in FIG. 7B, a tilted wavefront adds constructively off-axis. This causes the interference pattern to translate in the far-field relative to the on-axis case In the example shown in FIG. 7C, a random wavefront results in an incoherent pedestal that is approximately N times larger than a coherent wavefront. If a linear phase ramp is applied across the emitters, the beam in the Fourier plane is scaled and translated, for example as shown in FIG. 8 which schematically illustrates a notional example of detectors used to steer an array.

From Fourier optics, the array in the near field may be expressed as a sub-aperture function d(x) convolved with an impulse train E(x)=d(x)*Σᵢδ(x−iΔx) where the impulse train is p(x)=Σᵢδ(x−iΔx) with Fourier transform \tilde{p}(k). If a linear phase shift is applied e^{ik}^{₀}^{x} across the array (an impulse train), the Fourier transform of the impulse train is translated \tilde{p}(k)→\tilde{p}(k−k₀). The Fourier transform of the array then becomes the Fourier transform of the subaperture \tilde{d}(k) multiplied by the Fourier transform of the impulse train \tilde{p}(k−k₀). The sub-aperture envelope in the Fourier plane (focal plane of the lens) then determines the scaling of the translated beam peak, whereas the tilt determines the translation.

It is also worth noting that the steering distance in the Fourier plane may be arrived at from a combination of Geometric and Fourier optics. Accordingly, a beam of width D in the near-field gives rise to a diffraction limited beam size of λ/Dƒ in the focal plane of a lens. Knowing that a lens translates a beam in the focal plane by αƒ, it follows that a phase tilt in the aperture plane of λ/D corresponding to a phase shift of 2π/D across the array translates the beam in the far-field by one diffraction limited beam spot. A tilt of approximately +/−N/2 2π/D will therefore steer the beam by approximately +/−N/2 diffraction limited beam spots.

Additionally, note that incoherent phasing of the individual emitters may result in an incoherent pedestal in the focal plane of the lens consistent with the far-field of the individual emitter element. It follows that for N elements, the width of the coherent array is approximately N times larger in the near field than an individual subaperture, resulting in a diffraction limited beam that is approximately N times narrower in the far-field relative to the Fourier transform of the sub-aperture d(x).

### Extending the Steering Range of SPGD

The far-field intensity pattern is only approximately parabolic over a finite range (~+/−0.5 beam width). In some examples, extending the steering range may be achieved using multiple far-field detectors. For example, when the steering range exceeds a beam width of +/−0.5λ/D (in angular units), the feedback signal for steering the beam +/−0.5λ/D about an angle Nλ/D may be obtained using a detector positioned at an angle Nλ/D.

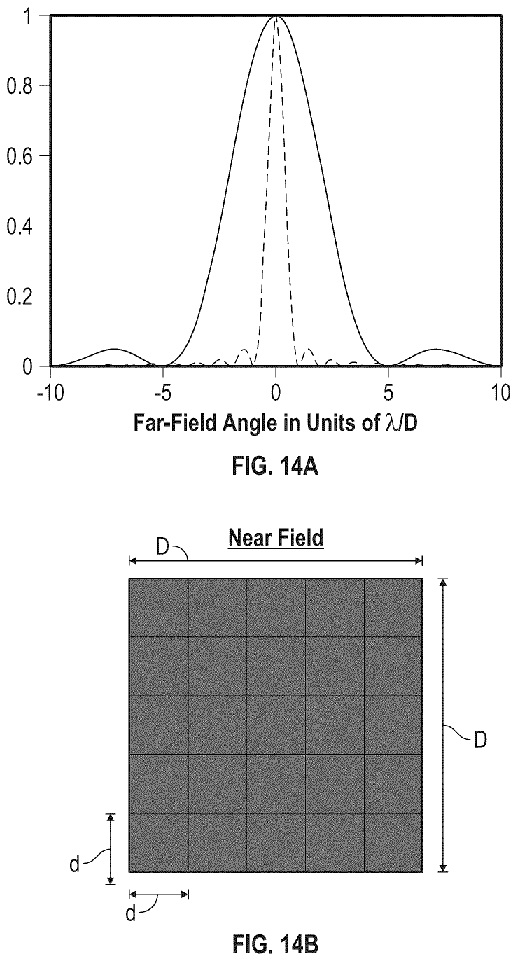

As an example, consider a 25 element square array as shown in FIGS. 14A-14B. The individual square elements of dimension d give rise to the far-field element pattern with an intensity pattern which may be expressed as:

$$I ( θ x , θ y ) = {I}_{0} sin {c}^{2} ( \frac{d θ x}{λ} ) sin {c}^{2} ( \frac{d θ y}{λ} ) . \qquad ( 12 )$$

The far-field element pattern shown in solid line contains nulls at angles λ/d=λN/D. In one nonlimiting example, N=5 is the number of elements. Because d=D/5 in this example, FIGS. 14A-14B illustrate the nulls of the element function located at +/−5λ/D. The array pattern, shown in dashed line in FIG. 14A is of the form expressed in equation 12, except the array dimension D=Nd is substituted for d. The array pattern is therefore N times narrower and may be steered within the element pattern by appropriate application of a phase tilt across the array.

FIG. 15 schematically illustrates a notional example of detectors used to steer an array. Placing detectors in an angular grid of spacing λ/D allows interpolation in between detector locations. Noting that the maximum steering range for an N element optical phased array is N beamwidths, the maximum number of detectors required is 2N per axis with an overall maximum of 4N², although more or fewer detectors may be used in any given practical implementation. In practice, because the main lobe is circularly symmetric in the far-field, the number of detectors needed is smaller because not all of the detectors placed on a uniform grid spacing are inscribed by the main lobe. Furthermore, it may not necessarily be desirable to steer to the extremes of the main lobe as the intensity drops to zero at the nulls. in some examples, the detector locations may be tailored to the specific element function and array pattern beyond the square geometry considered in this example. In addition, if the desired steering range for a specific system is less than the total allowable range then the number of detectors may be further reduced. For example, if a communication link budget may only tolerate a 50% intensity loss then the allowable steering range would correspond to the far-field angular diameter where the element function pattern is reduced to 50% which is less than the null to null diameter. Furthermore, the feedback used to close the SPGD loop has focused on interpolation of the maximum. It is also possible to interpolate the SPGD feedback based on minimizing the intensity at an offset from the detector location in addition to the maximum. Further extension may allow combinations of maximizing the SPGD signal at interpolated positions from one or more detectors while minimizing the SPGD signal at an interpolated position from yet one or more other detectors.

In some examples, system 100 further includes a gimbal to mechanically orient aperture 110 through which the receive beam is received and the transmitted beam is transmitted, wherein the gimbal is the only mechanical steering component used in the system. For example, controller 190 may be configured to determine, based on signals from detector array 180 and track/com sensors 130 or quad detectors 130′, that aperture 110 is pointed too far away from the remote device to be able to align the receive and transmit beams using only phase control; and may be configured to mechanically orient aperture 110 in that circumstance. In practice, the angular error measured by 180 and track/com sensors 130 or quad detectors 130′ is sent simultaneously to the gimbal controller and phased array controller so that both controllers act to minimize the error. The gimbal feedback is typically much slower than the phased array (non-mechanical) control loop to minimize cross-talk between the control loops. This is similar to common practice where a gimbal control loop is used a conjunction with a fast steering mirror to minimize the angular error. In these systems, the fast steering mirror provides the fine fast steering (typically over an order of magnitude higher bandwidth) than the coarse gimbal control. In the present invention, the phased array receiver effectively performs the function of a fast fine track steering mirror using all electronic phase control.

### Example Sensors

It will be appreciated that any components described with reference to FIGS. 1A, 2A-2B, and 3 suitably may be varied. For example, FIGS. 4A-4E schematically illustrate other example sensors for use in determining direction of a received beam.

Referring now to FIG. 4A, an example multimode fiber implementation of the track/com sensor of FIGS. 1A and 3 is schematically illustrated. Sensor 400 illustrated in FIG. 4A may include a single-mode optical fiber 430, and a plurality of multi-mode optical fibers 431 arranged around the single-mode optical fiber 430 in a plane. Each of the multi-mode optical fibers may have any suitable characteristics, illustratively a numerical aperture (NA) of at least about 0.3, and/or may support at least about 500 different modes.

Sensor 400 further may include at least one optical element configured to direct the optical beam to the single-mode optical fiber when the optical beam is on-axis, to generate a single-mode guided beam, and to direct the optical beam to one of the multi-mode optical fibers when the optical beam is off-axis to generate a multi-mode guided beam. Illustratively, the at least one optical element may include lenses 123, 124, and/or 125 described with reference to FIG. 1A (lens 125 being illustrated in FIG. 4A for simplicity). Additionally, or alternatively, the at least one optical element may include at least one phase plate such as described below with reference to FIG. 4B. Additionally, or alternatively, the at least one optical element may include a lens and a lens array, wherein the lens array is disposed between the lens and the plane, e.g., such as described below with reference to FIG. 4C.

In some examples, sensor 400 optionally may include a controller (e.g., controller 190 described with reference to FIG. 1A). The controller may be configured to use the single-mode guided beam, when present, to characterize the optical beam as being on-axis. The controller also may be configured to use the multi-mode guided beam, when present, to characterize an off-axis angle and wavefront tilt of the optical beam.

In some examples, the plurality of multi-mode optical fibers 431 includes (i) a first multi-mode optical fiber configured to receive the optical beam when the optical beam is in a first quadrant of the plane; (ii) a second multi-mode optical fiber configured to receive the optical beam when the optical beam is in a second quadrant of the plane; (iii) a third multi-mode optical fiber configured to receive the optical beam when the optical beam is in a third quadrant of the plane; and (iv) a fourth multi-mode optical fiber configured to receive the optical beam when the optical beam is in a fourth quadrant of the plane. That is, the multi-mode optical fibers may be disposed in respective quadrants, similarly as quadrants 331 illustrated in FIG. 3.

Consider a simplified 1-dimensional representation of the multimode fiber as including, or consisting essentially of, a phased array of fibers with subapertures of size D/n, where D is the mode field diameter of a single-mode fiber (illustratively, D may be approximately 10 μm for 1550 nm single mode fiber to 6 μm for 1064 nm single mode fiber). Generally speaking, the mode field diameter is a function of the waveguide core width and the numerical aperture of the waveguide. In this model, n represents the number of elements in the array equivalent of the multimode fiber. Since the diffraction angle of the array equivalent is λn/D which is made equal to the numerical aperture NA of the multimode fiber, and given the diffraction angle of a single mode fiber is λ/D, the number of effective elements is given by n=NA/(λ/D). The top phased array shown in FIG. 4A maps to the top quadrant, whereas the bottom phased array shown in dark gray maps to the bottom quadrant. The single-mode fiber shown in the center corresponds to the single-mode core 330 described with reference to FIG. 3. As shown in FIG. 4A, the envelope of the diffraction angle of the phased array may be expressed as λ/d, where d is the subaperture corresponding to the central single-mode fiber and λ is the optical wavelength. Because d=D/n, where D is the total size of the array, the envelope is n times larger than the diffraction angle that would correspond to an aperture of size D.

When an array is coherent, an ensemble of subapertures acting collectively and incoherently is indistinguishable from a single element of the same power and of aperture size D (where D=nd). Therefore, under coherent phasing the brightness is increased and the main-lobe is reduced to 1/N times the envelope width (to λ/D). The increased brightness results from the coherent phasing, which effectively focuses the power in the far-field by effectively increasing the aperture size in the near-field. Because there are N degrees of freedom in the phased array, the main lobe may be steered to N positions within the envelope of width Nλ/D.

Referring still to FIG. 4A, a lens may be used in plane P2 (e.g., lens 125 illustrated in FIG. 1A) to match the beam emitting from a single-mode fiber located in plane P1. In one purely illustrative example, the lens may be of size 2 mm. To achieve an example dynamic range of 2 mrad/(30 μrads), a spot size of 30 μm may be used, similarly as described with reference to FIG. 3. For this example spot size, ƒ=2 mm (30 μm/λ), or approximately 40 mm. As the beam steers off boresight, the beam moves in plane P1. The number of beam widths that can be steered and captured by the phased array is approximately equal to the number of emitters (modes) for an appropriately sized array. Illustratively, to achieve a field-of-view of 67 beam widths, 67 modes or phased array elements may be used.

Note that while the phased array may be used an example to illustrate that N beam positions can be mapped to such an array representing the multimode fiber, it is not critical to phase the array because the array is to be used to determine the total power in the ensemble or array elements representing the ensemble of the number of modes. In other words, reciprocity dictates that if an array could produce the displaced spot in plane P1, the reverse process also holds. A displaced spot may excite a superposition of modes in the received array with the phase needed to match the displaced spot. When there are sufficient degrees of freedom to create the displaced beam in the forward direction, the same holds true in reverse. The power in the number of modes is used to infer the power in the displaced beam that allows determining the angle of arrival. If all the power is in the left quadrants, then it is inferred that beam is tilted in that direction. If the power is equal on both the left and right quadrants, it is inferred that the beam is arriving on-axis.

Additionally, note that a phased array is not necessary and may be replaced by a multimode fiber. Indeed, in the limit that spacing between array elements approaches zero, the function of the phased array may be similar (if not equivalent) to that of a multimode fiber. The number of array elements N is therefore, in some examples, analogous to the number of modes N in a multimode fiber.

Further, while the amplitude at Plane P1 produced by the phased array matches the amplitude of focused beam incident from a lens from Plane P2, a phase plate of conjugate phase may be used to flatten the phase of the beam incident from Plane P0.

FIG. 4B schematically illustrate an example phase element which may be used at Plane P1 in FIG. 4A to conjugate the phase. In some examples, it is beneficial to have more modes (finer resolution) to expand the multimode fiber envelope to be larger than necessary. This allows for a more uniform profile (closer to a top-hat) near the single-mode fiber envelope (centrally located).

In one purely illustrative example, the distance z between planes P0 and P1 in FIG. 4A to achieve a 30 μm beam from a 10 μm diverging single-mode fiber size is 200 μm. The central phase element shown in dark gray would correspond to a microlens appropriate to collimate a 30 μm beam diameter originating from a 10 μm source a distance 200 μm away (e.g., conjugate of Gaussian phase profile). The multimode fiber phase profile on the phase element of FIG. 4B, at plane P1 in FIG. 4A, may correspond to the conjugate of the phase resulting from the divergence of an effective beam diameter emitted from the top and bottom multimode fibers incident on the Plane P2 in FIG. 4A.

The effective beam diameter may be calculated in any suitable manner. The V number may be expressed as 2πα/λ, where α is the radius of the core of the fiber and the Gaussian beam divergence may be expressed as λ/(πα). As known by those of ordinary skill in the art, the V number is a quantity that is used in describing the number of modes in a fiber, and may be used as a measure of how many have wavelengths could fit to meet the boundary condition (for example zero field at the boundary for perfectly conducting waveguides). For a fiber, the NA comes into play because the mode could penetrate the boundary depending on the index contrast. The total number of modes may be approximately expressed as V²/2. The number of modes per axis in both polarizations may be approximately expressed as V/sqrt(2). The effective diameter corresponding to this divergence angle is d=(2λ/(π NA). As one purely illustrative, nonlimiting example, consider a multimode fiber corresponding to 200 μm core fiber diameter, optical wavelength 1.5 μm, and numerical aperture (NA) 0.50. Here, the V number is approximately 209; there are approximately 147 total modes in both polarizations; and there are approximately 74 modes per axis per polarization. The effective diameter corresponding to a divergence angle of λ/(πα) is approximately 2 μm. The number of distinct 2 μm spots in the 200 μm core fiber is therefore approximately 100, which is less than but similar to the expected number of modes. However, 100 modes are expected to contain enough degrees of freedom to image 66 unique beam spot locations at plane P1. Additionally, the divergence of the multimode fiber is approximately five times that of a single-mode fiber. For an example ratio of 44:1 distinguishable spots (e.g., 1.2 mrad/30 μrad) per multimode fiber, the multimode fiber may be displaced at least about 8.8 times (that is, about 44 times divided by 5) behind the plane of the single-mode fiber, for a total distance of 2.8 mm.

A notional design is illustrated in FIG. 4C. The general design approach involves choosing a multimode fiber that has a sufficient numerical aperture that will match the desired angular tracking range (typically 2 mrads in big beam space that is magnified by the angular magnification of the telescope in the small beam space). Optics are then designed at plane P1 to conjugate the NA of the multimode fiber to achieve a flattened phase of an effective subaperture of the multimode fiber (2 μm in the example above). The central portion of the optics at Plane P1 are designed to achieve a flat phase from the single mode fiber. The focusing lens at plane P2 is used to match the mode of the single mode fiber at plane P1 for an incoming beam on-axis while being of a size equivalent to the pitch of optical phased array in small beam space as illustrated in FIG. 4D. The faster angle of the multimode fiber than the single mode fiber plays a role in determining the axial displacement of the multimode fiber relative to the single mode fiber.

Alternate designs may be used. Each multimode fiber may be replaced with multiple multi-mode fibers to further extend the angular tracking range. The corresponding phase element as plane P1 would change accordingly. Design variants may be found that do not require an intermediate collimation element for the single-mode fiber at Plane P1. In some examples, the notional design in FIG. 4C uses an intermediate collimation step (e.g., lenses 124 and 125 forming a telescope imaging the focal plane of lens 123 onto the fibers). Illustratively, in some examples only about 20 degrees of freedom (e.g., 20/200 μm) may be available with a single multi-mode fiber and therefore may not necessarily provide the desired dynamic range.

Sensor 400 may be used to generate a receiver or transmitter phased array such as described elsewhere herein, e.g., in a manner such as illustrated in FIG. 4D. Specifically, the intensity of all the fibers are sent to a fiber coupled detector. Similarly as for a previously known all-electronic quadrant detector, the optical power detected in each quadrant may be used to determine the angle. If the four quadrants are respectively labeled A, B, C, D with A and B corresponding to the left quadrants and C and D corresponding to the right quadrants, the left and right angle may be determined by the difference in power (A+B−C+D)/(A+B+C+D). Additionally, and without loss of generality, each element cell may also or alternatively be magnified and synthesized into a larger aperture using telescope synthesis and coherent combination as shown in FIG. 4E. The angular magnifications may be accounted for when using a telescope. For instance, if the sensor is used in the small beam space of the telescope, the angle may be reduced by the angular magnification in commanding the gimbal aperture that resides in the big beam space.

Sensors such as described with reference to FIGS. 4A-4E may be used in any suitable method for characterizing alignment of an optical beam. For example, when the optical beam is on-axis, the optical beam may be directed to a single-mode optical fiber to generate a single-mode guided beam. Additionally, when the optical beam is off-axis, the optical beam may be directed to a multi-mode optical fiber of a plurality of multi-mode optical fibers arranged around the single-mode optical fiber in a plane, to generate a multi-mode guided beam. The single-mode guided beam, when present, may be used to characterize the optical beam as being on-axis. The multi-mode guided beam, when present, may be used to characterize an off-axis angle and wavefront tilt of the optical beam. Such methods, and sensors, optionally may be used in system 100 described with reference to FIG. 1A.

### Example Methods

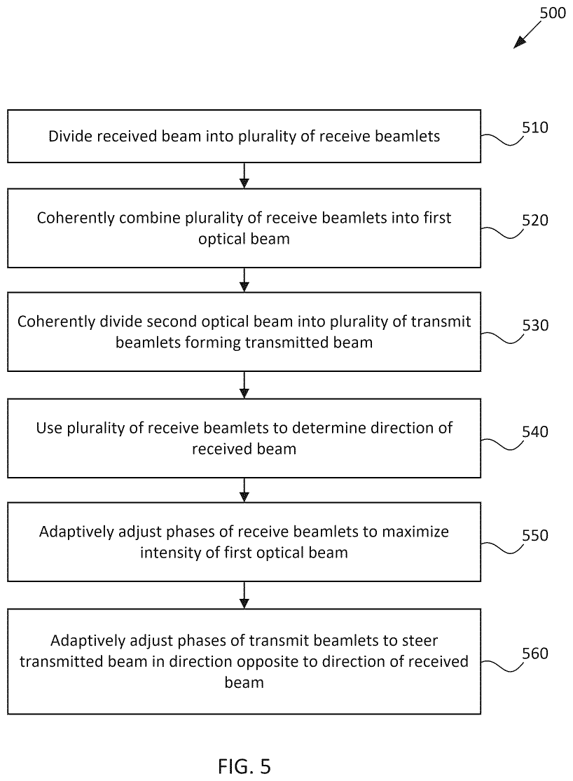

FIG. 5 illustrates a flow of operations in an example method 500 for optically aligning a transmitted beam with a received beam. Method 500 may include dividing a received beam into a plurality of receive beamlets (operation 510). Any suitable combination of free space optics and guided-wave optics (e.g., fiber optics) may be used to divide the received beam (incoming beam) into receive beamlets. For example, in a manner such as described with reference to FIGS. 1A and 1B, lenses 123, 124, 125 may focus portions of the received beam into fiber optics within respective track/com sensors 130 or quad detectors 130′. Method 500 also may include coherently combining the plurality of receive beamlets into a first optical beam (operation 520). The beamlets may be coherently combined in any suitable manner. For example, in a manner such as described with reference to FIGS. 1A, 1B, and 2A, first beam combiner 140 may coherently combine receive beamlets 240 into first optical beam 242 which may be output to receiver 141. Method 500 also may include coherently dividing a second optical beam into a plurality of transmit beamlets forming a transmitted beam (operation 530). The second optical beam may be coherently divided in any suitable manner. For example, in a manner such as described with reference to FIGS. 1A, 1B, and 2B, second beam combiner 150 (which also may be referred to as a beam splitter) may coherently divide second optical beam 252 from transmitter 151 into transmit beamlets 250.

Method 500 illustrated in FIG. 5 also may include using the plurality of receive beamlets to determine a direction of the received beam (operation 540). For example, in a manner such as described with reference to FIGS. 1A and 1B, controller 190 may include a receive track sensor module 191 that receives signals from track/com sensors 130 and quad detectors 130′ representing the direction and degree by which each of the receive beamlets is off-axis. Detectors may have any suitable configuration, e.g., such as described with reference to FIG. 3, or with reference to FIGS. 4A-4E. Method 500 illustrated in FIG. 5 also may include adaptively adjusting phases of the receive beamlets to maximize intensity of the first optical beam (operation 550). For example, in a manner such as described with reference to FIGS. 1A, 1B, and 2A, controller 190 may include a receive phase control module 192 that receives feedback from the measured intensity in the first optical beam 242, and controls first phase modulator array 243 to adjust phases of the receive beamlets to maximize intensity of the first optical beam, e.g., while simultaneously commanding the gimbal to center the receive beamlets on their respective detectors 130 resulting in maximum intensity in the received beamlets 240 which are combined in phase with one another to maximize the intensity of the first optical beam 242. Method 500 illustrated in FIG. 5 also may include adaptively adjusting phases of the transmit beamlets to steer the transmitted beam in a direction opposite to the direction of the received beam (operation 560). For example, in a manner such as described with reference to FIGS. 1A, 1B and 2B, controller 190 may include a transmit phase control module 193 that receives feedback from detector array 180, and controls second phase modulator array 253 to adjust phases of the transmit beamlets to maximize intensity of the transmit beam in the far field of aperture 110.

### Example Implementation

The controller functions described herein may be implemented using any suitable combination of hardware and software. For example, any suitable controller functionalities described herein may be implemented using a suitably programmed field-programmable gate array (FPGA) or application-specific integrated circuit (ASIC). FPGAs and ASICs are commercially available, and methods of programming same to achieve desired logical programming are known in the art. In still other configurations, the controller functionalities described herein may be implemented using a suitably programmed computer, e.g., a suitably programmed general purpose computer including a non-volatile computer-readable medium storing instructions for causing the computer to perform such functions.

### WORKING EXAMPLES

The following examples are intended to be purely illustrative, and not limiting of the present subject matter.

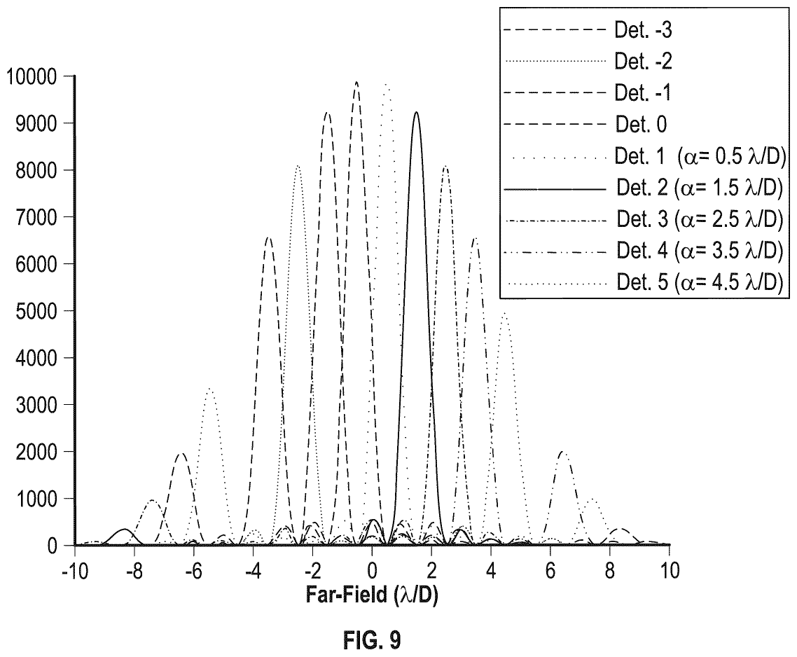

FIG. 9 illustrates simulated results from a phased array, more specifically the phased array of FIG. 8. Each detector (Det. N, where N is −3 to 5) is placed at Nλ/D in the far-field. The beam is commanded to steer −0.5λ/D from each detector. The initial phase across the array is random. The modified SPGD algorithm described herein is applied to phase the array (generating a coherent peak) while simultaneously steering the array. Beam profiles are shown corresponding to angles ranging from −3.5λ/D to 4.5λ/D corresponding to a steering range of 7 far-field beam spots using 7 detectors. The simulated array corresponds to a 1-D ten-element array. The results can be extended to 2-D. In these simulations, the novel SPGD expression derived in eq. 9 was used. The offsets for each dither vector (offset,i) was determined as a function of the steering angle offset α for a detector located at angle α₀. Because only the relative angular offset matters, the offset parameter offset,i is identical for each detector. Moreover, the dither dependent offset is linear within the linear interpolation range and may be expressed as offset,i=cᵢ α, where cᵢ is the to be determined proportionality constant. The constant may be determined through measurement (or analytically) by observing the response

$$( \frac{( {J}^{+} - {J}^{-} )}{( {J}^{+} + {J}^{-} )}$$

of a detector used for calibration positioned at the offset angle alpha when the optical phased array is coherently combined on a detector located at α₀ (zero offset). Knowing the offset angle, the proportionality constant may be determined. Analytically, the phased array may be simulated with flat phase (zero phase error). The quantity

$$( \frac{( {J}^{+} - {J}^{-} )}{( {J}^{+} + {J}^{-} )}$$

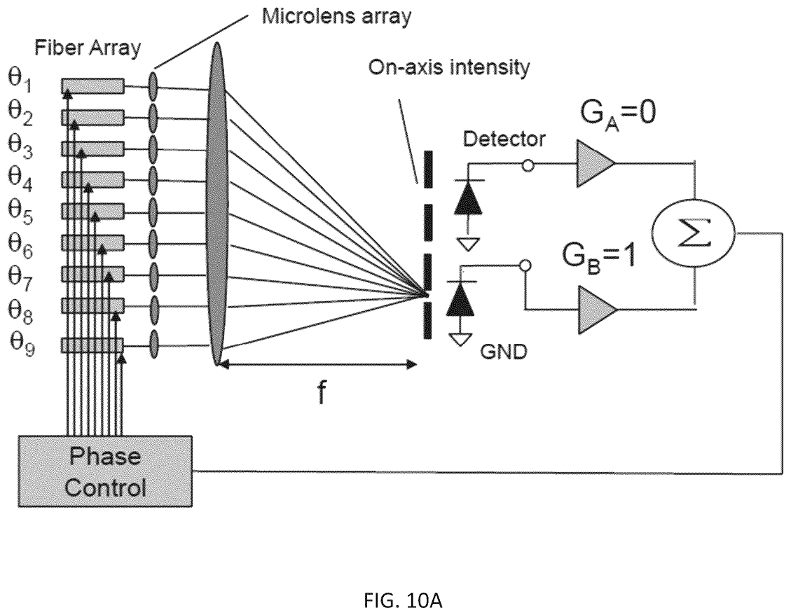

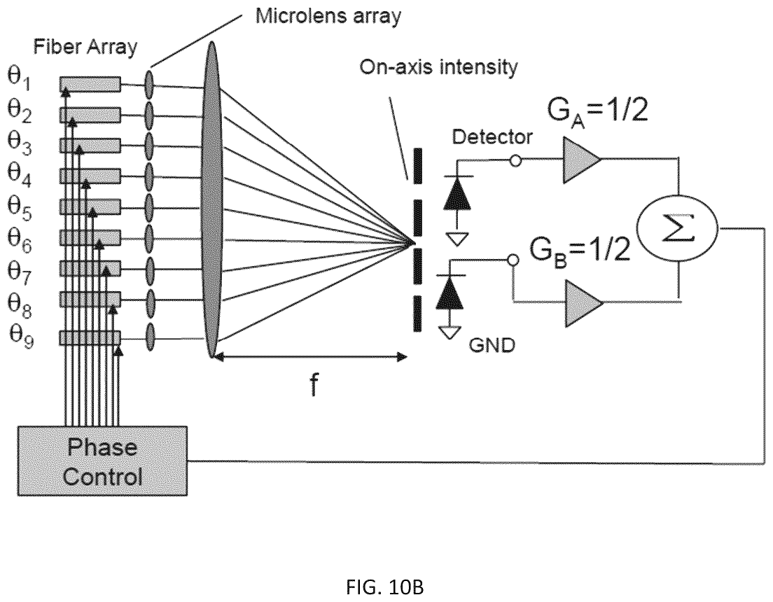

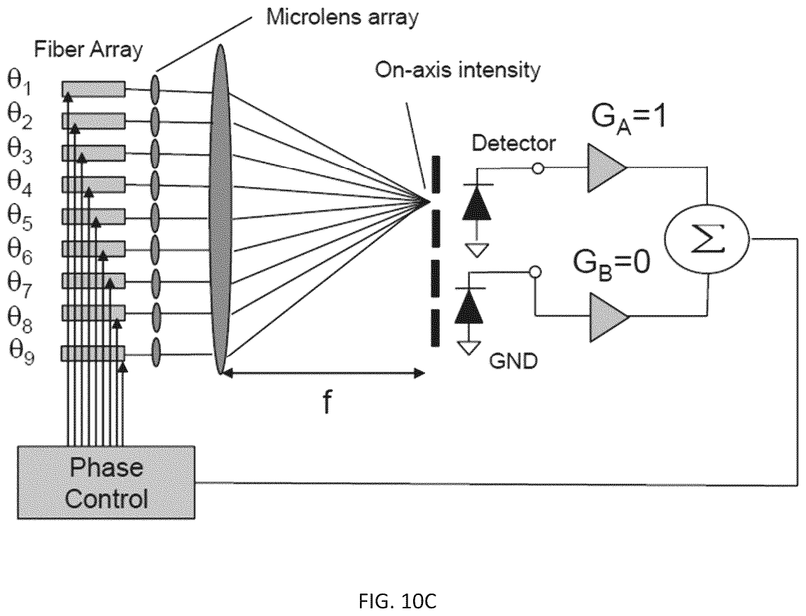

may be determined by inspecting the response to each dither at an offset. With the simulated quantity and knowledge of the offset angle, the proportionality constant may be determined for each dither. Alternatively, another implementation involving two detectors spaced half a beam width apart may be implemented using the novel SPGD equation of the form expressed in equation 10 and depicted in FIGS. 10A-10C.

FIGS. 10A-10C schematically illustrate example uses of a phased array to steer a transmitted beam. More specifically, a schematic representation of a nine-element phased array control system is shown in FIGS. 10A-10C. The nine optical elements were arranged in a 3×3 2-D geometry and were focused onto a detector array. The analog inputs of the detector array were digitized, and the modified stochastic parallel gradient descent (SPGD) algorithm described in eq. 10 was used to optimize the intensity on one of the detectors in the array. Optimizing the intensity on discrete detectors in the far-field allowed the beam to be steered to discrete locations. When the detector was blocked, the measured far-field pattern was consistent with incoherent combination of the nine fiber array elements. When the detector was unblocked, the modified SPGD algorithm optimized the individual phase elements to maximize power on the detector.

The far-field pattern consisted of a main-lobe along with discrete side-lobes as expected due to the finite fill-factor of the array. In some examples, the fill-factor may be further optimized through the use of known techniques including optimizing the microlens array design to achieve an improved fill-factor, e.g., in a manner such as described in Swanson et al., “Aperture filling of phase-locked laser arrays,” Optics Letters 12 (4): 245-247 (1987), the entire contents of which are incorporated by reference herein.

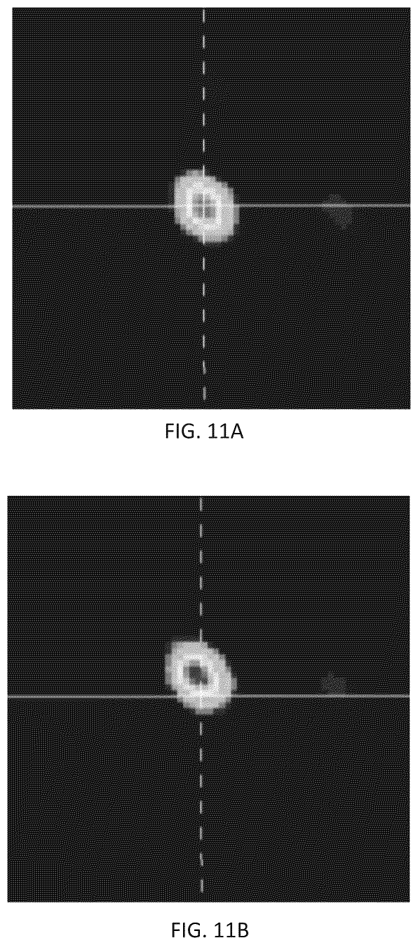

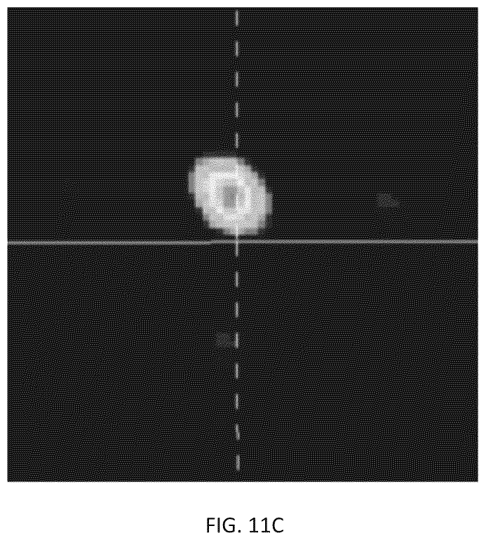

The phased array was steered to different locations in the far-field by closing the feedback loop on discrete detectors as shown in FIGS. 10A and 10C. In FIG. 10B, the beam was interpolated to be steered in between the two discrete detectors where no detector was present as a proof-of-concept of the novel steering approach. Achieving non-mechanical steering is also possible through the use of discrete far-field detectors. FIGS. 11A-11C are two-dimensional phase control results generated using the phased array in the manner described with reference to FIGS. 10A-10C. FIG. 11A corresponds to Δ=−1, G_{B}=1, G_{A}=0 and results in beam steering to the bottom detector. FIG. 11B corresponds to Δ<0, G_{A}=½, and G_{B}=½ and results in interpolated steering midway between the top and bottom detectors. FIG. 11C corresponds to Δ=1, G_{A}=1, and G_{B}=0 and results in beam steering to the top detector. Other values of A not shown allowed for arbitrary steering to any location between the top and bottom detectors. Additional detectors may be used to expand the steering range and may be arranged to allow for steering along the orthogonal axis.

### Additional Examples

While various illustrative embodiments of the invention are described above, it will be apparent to one skilled in the art that various changes and modifications can be made therein without departing from the invention. The appended claims are intended to cover all such changes and modifications that fall within the true spirit and scope of the invention.

1. A method for aligning a transmitted beam with a received beam, the method comprising:
dividing a received beam into a plurality of receive beamlets;
coherently combining the plurality of receive beamlets into a first optical beam;
coherently dividing a second optical beam into a plurality of transmit beamlets forming a transmitted beam;
using the plurality of receive beamlets to determine a direction of the received beam;
adaptively adjusting phases of the receive beamlets to maximize intensity of the first optical beam; and
adaptively adjusting phases of the transmit beamlets to steer the transmitted beam in a direction opposite to the direction of the received beam.

2. The method of claim 1, wherein the phases of the receive beamlets are adaptively adjusting using a first two-dimensional array of phase modulators, and wherein the phases of the transmit beamlets are adaptively adjusted using a second two-dimensional array of phase modulators.

3. The method of claim 1, wherein adaptively adjusting the phases of the receive beamlets comprises:
individually detecting whether the average of the receive beamlets is on-axis or off-axis; and for any average of the received beamlets to be detected off-axis, commanding the gimbal to steer the average on axis, while adaptively adjusting the phase of the individual receive beamlets until is the received beamlets are combined in phase to form the first optical beam.

4. The method of claim 1, wherein determining the direction of the received beam comprises using a plurality of corresponding sensors to individually detect whether each of the receive beamlets is on-axis or off-axis,
each of the corresponding sensors comprising a single-mode optical fiber,
wherein when the receive beamlet is on-axis, the single-mode optical fiber of the corresponding sensor generates a single-mode guided beam that coherently combines with other single-mode guided beams from other on-axis receive beamlets.

5. The method of claim 1, wherein determining the direction of the received beam comprises using a plurality of detectors oriented at relative in-plane angles to each other, such that a comparison of the angle of arrival in the rotated references frames resolves the ambiguity relative to a common (non-rotated) reference frame.

6. The method of claim 1, wherein adaptively adjusting the phases of the transmit beamlets comprises:
detecting intensity of the transmit beam at a far-field of an aperture; and
adaptively phase shifting one or more of the transmit beamlets to increase the detected intensity of the transmit beam at the far-field of the aperture.

7. The method of claim 1, wherein phases of the receive beamlets or phases of the transmit beamlets are adaptively adjusted using a closed loop algorithm.

8. The method of claim 7, wherein the closed loop algorithm comprises a modified stochastic parallel gradient descent (SPGD) algorithm.

9. The method of claim 1, further comprising using a gimbal to mechanically orient an aperture through which the received beam is received and the transmitted beam is transmitted, wherein the gimbal is the only mechanical steering component used in the method.

10. The method of claim 1, wherein the received beam is at a first wavelength, and the transmitted beam is at a second wavelength that is different than the first wavelength.

11. The method of claim 1, wherein the received beam carries a first signal, and the transmitted beam carries a second signal.

12. A system for aligning a transmitted beam with a received beam, the system comprising:
a first beam combiner to coherently combine a plurality of receive beamlets into a first optical beam;
a plurality of sensors to determine a direction of the received beam;
a first phase modulator array to adjust phases of the receive beamlets;
a second beam combiner to coherently divide a second optical beam into a plurality of transmit beamlets forming a transmitted beam;
a second phase modulator array to adjust phases of the transmit beamlets; and
a controller to:
adaptively adjust the first phase modulator array to maximize intensity of the first optical beam; and
adaptively adjust the second phase modulator array to steer the transmitted beam in a direction opposite the direction of the received beam.

13. The system of claim 12, wherein the controller is to adaptively adjust the first phase modulator array using operations comprising:
individually detecting whether the average of the receive beamlets is on-axis or off-axis; and
for any average of the received beamlets detected to be off-axis, commanding the gimbal to steer the average on-axis, while adaptively adjusting the individual receive beamlets until the received beamlets are combined in phase to form the first optical beam.

14. The system of claim 12, wherein the plurality of sensors are configured to individually detect whether corresponding ones of the receive beamlets are on-axis or off-axis,
each of the sensors comprising a single-mode optical fiber,
wherein when the corresponding receive beamlet is on-axis, the single-mode optical fiber of the sensor generates a single-mode guided beam that is coherently combined with other single-mode guided beams from other on-axis receive beamlets.

15. The system of claim 12, wherein the controller is to adaptively adjust the second phase modulator array using operations comprising:
detecting an intensity of transmitted beam at a far-field of an aperture; and
adaptively phase shifting one or more of the transmit beamlets to increase the intensity of the transmitted beam at a far-field of the aperture.

16. The system of claim 15, wherein the intensity of the transmit beam at the aperture is detected using a tap of the transmitted beam focused onto one or more detectors.

17. The system of claim 12, wherein the controller is to adaptively adjust phases of the receive beamlets or phases of the transmit beamlets using a closed loop algorithm.

18. The system of claim 17, wherein the closed loop algorithm comprises a modified stochastic parallel gradient descent (SPGD) algorithm.

19. The system of claim 12, wherein the received beam is at a first wavelength, and the transmitted beam is at a second wavelength that is different than the first wavelength.

20. The system of claim 12, wherein the received beam carries a first signal, and the transmitted beam carries a second signal.

21. The system of claim 12, further comprising a gimbal to mechanically orient an aperture through which the receive beam is received and the transmitted beam is transmitted, wherein the gimbal is the only mechanical steering component used in the system.

22-37. (canceled)
